(19) United States
(12) Patent Application Publication
(10) Pub. No.: US 2003/0013046 A1
(43) Pub. Date: Jan. 16, 2003

(54) Use of sacrificial layers in the manufacturing of chemical reactor structures and the application of such structures

(75) Inventors: Stephen J. Fonash, State College, PA (US); Wook Jun Nam, State College, PA (US); Kyuhwan Chang, State College, PA (US); Henry C. Foley, State College, PA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: THE PENN STATE RESEARCH FOUNDATION, UNIVERSITY PARK, PENNSYLVANIA

(21) Appl. No.: 10/186,252

(22) Filed: Jun. 28, 2002

Related U.S. Application Data
(60) Provisional application No. 60/302,143, filed on Jun. 29, 2001.

(51) Int. Cl. G03C 5/56; H01B 13/00

(52) U.S. Cl. 430/314; 430/317; 430/320; 438/149; 216/17; 216/40

(57) ABSTRACT

There is disclosed a method of producing nano or micro-scale chemical reactor devices and novel devices produced by said method. The method of the invention uses deposited sacrificial layers to provide various channels and reservoirs of reactor devices. Reactor devices of the present invention are chemical reactor devices, electro-chemical reactor devices, or chemical/electro-chemical deivices. A fuel cell embodiment is disclosed.

This application claims priority from U.S. Provisional Application No. 60/302,143, filed Jun. 29, 2001.

### BACKGROUND OF INVENTION

1. Field of the Invention

The present invention relates to a novel chemical and electro-chemical devices and method for the manufacture of such devices.

2. Description of the Prior Art

Nano and Micro scale surface micromachining technology has attracted a great deal of interest because of its wide impact on numerous fluid-flow-based technologies. Surface micromachined structures are being utilized for applications in micro fluidics such as nozzle structures, systems for drug diffusion and delivery, nebulizers, chromatographic separation, and filtering. Micromachined systems have already made a significant impact on developing automated, high throughput analysis systems for chemical, organic and biological assays.

The invention discussed here focuses on the fabrication and applications of micro- and nano-scale, surface micro-machined gap, cavity, and channel structures. The technologies presented in this invention for gap, cavity and channel formation have allowed us to develop novel chemical and electro-chemical reactor structures. The invention is based on using deposited films built into the ceiling, floor, or both of these chemical or electrochemical reactors. These films can serve a catalytic function, a voltage or current source or collector function, or a transport/orientation function, or some combination of all three. Our approach to creating these reactors is very unique because it employs deposited thin films, unique island formation approaches, and lift-off using deposited sacrificial layers for gap, cavity and channel formation.

### SUMMARY OF THE INVENTION

The present invention is directed to nano or microscale chemical or electrochemical reactor devices. The reactors of the present invention include, but are not limited to: (a) at least one reservoir for storing and injecting reactant(s); (b) at least one reservoir for storing and collecting reaction product(s); and (c) at least one micro-channel or micro-cavity disposed between the reactant reservoir and the product reservoir; and (d) a catalytic structure embedded in said micro-channel or micro-cavity.

The catalytic structures of the chemical and electro-chemical reactors of the present invention may include, but are not limited to, a discontinuous film structure, a discontinuous grid structure, a continuous film structure and a continuous grid structure. The catalytic structures of the reactors of the invention may further comprise noble metals, active metals, transition metals, non-metals, alkali metals, alkaline earth metals, halogens, and combinations thereof and specifically platinum, palladium, platinum alloys and palladium alloys. Also, the continuous film structure and continuous grid structure of the above electrochemical reactor may optionally be connected to an electrical voltage source or an electrical current source, heat source or light source.

The continuous film structure and continuous grid structure of the reactors of the present invention may collect electrical power, facilitate chemical or electrochemical processes, transport polar molecules or orientate polar molecules. In an embodiment of the present invention, a chemical reactor device may further comprise a catalyst embedded in one of the walls, or sides which constrain the volume of the reactor. Also, the chemical and electro-chemical reactor devices of the invention may further comprise a grid structure embedded in the walls of the channel, allowing additional reactants to enter the channel and reaction products to exit the channel.

A preferred embodiment of the present invention is a micro-scale fuel cell, including but not limited to: (a) at least one reservoir for storing and injecting a reactant; (b) a at least one reservoir for storing and collecting a reaction product; c) at least one micro-channel or micro-cavity adjoining the reactant reservoir and product reservoir; (d) a first catalytic structure embedded in the micro-channel or micro-cavity; (e) a second catalytic structure embedded in the ceiling of the micro-channel or microcavity; (f) a proton membrane layer covering the ceiling catalyst; and (g) an electrode located on top of the proton permeable membrane layer.

The present invention discloses several methods for fabricating a nano or micro-scale chemical reactor, an embodiment of this method is (a) depositing a structural mask layer on a substrate; (b) patterning a microchannel region, a reactant reservoir region, and a product reservoir region in the mask layer; (c) depositing a sacrificial layer material on the substrate and patterned regions in the mask layer; (d) removing the sacrificial layer material in the mask layer regions by lifting-off the mask layer, whereby the mask layer remains on the substrate except in the channel and reservoir regions; (e) patterning a first catalyst layer, depositing a thin-film catalyst layer on the substrate, and lifting-off the thin-film catalyst layer; (f) depositing a covering layer on the substrate; (g) etching at least one hole through said covering layer, sacrificial layer, and a portion of the substrate; (h) depositing a second catalyst layer on the substrate; and (i) sealing the through holes by depositing a second covering layer.

The method of the present invention may as a preferred embodiment be used to fabricate a micro-scale fuel cell. The covering layer in the fuel cell, may comprises a proton membrane layer and the method further comprises depositing an electrode on top of the substrate.

The structural mask layer of the method of the invention may comprise a coated wafer, a coated plastic material, a coated ceramic material, a coated metal material, a coated foil material, a coated glass material, an uncoated wafer, an uncoated plastic material, an uncoated metal material, an uncoated ceramic material, an uncoated foil material and an uncoated glass material. The patterning process of the method of the present invention may comprise lithography, scribing, screen printing, shadow masking, embossing or laser ablation and any combinations thereof. The method of the invention may conveniently be used to fabricate a micro-scale electro-chemical reactor.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, preferred methods and materials are described below. All publications, patent applications and other references mentioned herein are incorporated by reference in their entirety. In the case of conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWINGS

FIG. 1 shows the cross-sectional view of the channel(s) region of the micro-scale or nano-scale chemical reactor of a configuration of this invention.

FIG. 2 shows the length-wise cross-section and operation of the overall micro-scale or nano-scale chemical reactor of a configuration of this invention.

FIG. 3 shows the general process sequence to manufacture the micro-scale or nano-scale chemical reactor of a configuration of this invention.

FIG. 4 shows another general process sequence, which uses the 1^{st} catalyst layer as a mask layer during the 2^{nd} catalyst layer deposition.

FIG. 5 shows the cross-sectional view of the channel region, which has been designed to operate as a fuel cell with the hydrogen-generating reactor.

FIG. 6 shows the operation of the overall fuel cell with microfluidic chemical reactor embedded in it.

FIG. 7 shows the length-wise cross-section and operation of the overall micro-scale or nano-scale chemical reactor with the reactants supply arrived on the outer surface.

FIG. 8 shows the general process sequence to manufacture the fuel cell with hydrogen-generating reactor embedded in it.

FIG. 9 shows the general process sequence to manufacture a chemical reactor, which contains a membrane electrode assembly.

FIG. 10 shows an example of chemical reactor with the flow field by etching part of the substrate and sacrificial layer from the backside.

FIG. 11 shows the test structure to investigate the proton conduction in the deposited high-surface-to-volume-ratio material.

FIG. 12 shows the effect of the relative humidity on the current between two electrodes on the deposited high-surface-to-volume-ratio material.

### DETAILED DESCRIPTION OF THE INVENTION

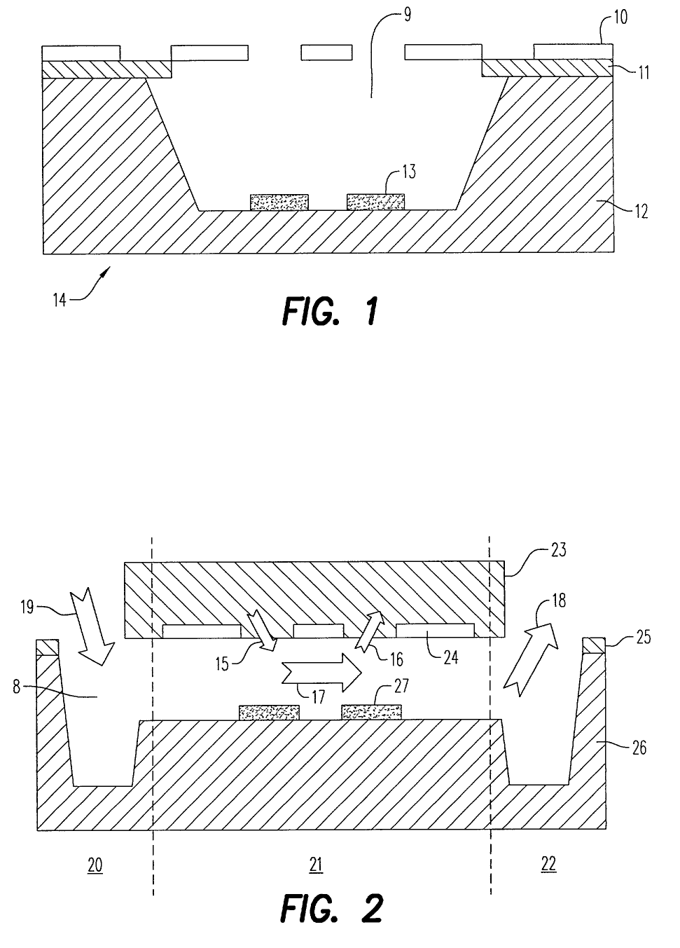

The micro-scale chemical reactor manufactured by this invention is shown in FIG. 1. The micro-scale chemical reactor in this invention consists of microchannel(s) or nanochannel(s) with catalytic structures, electrodes, screen-like (grid) electrodes, or some combination built into the wall(s), floor, or ceiling of such a channel or cavity.

Referring now to FIG. 1, there is shown a schematic cross-section representation of chemical reactor 14 of the invention. There is shown a microchannel 9, a first catalyst 10 island or screen layer, a structural mask layer 11, a substrate 12, and a second catalyst 13 island.

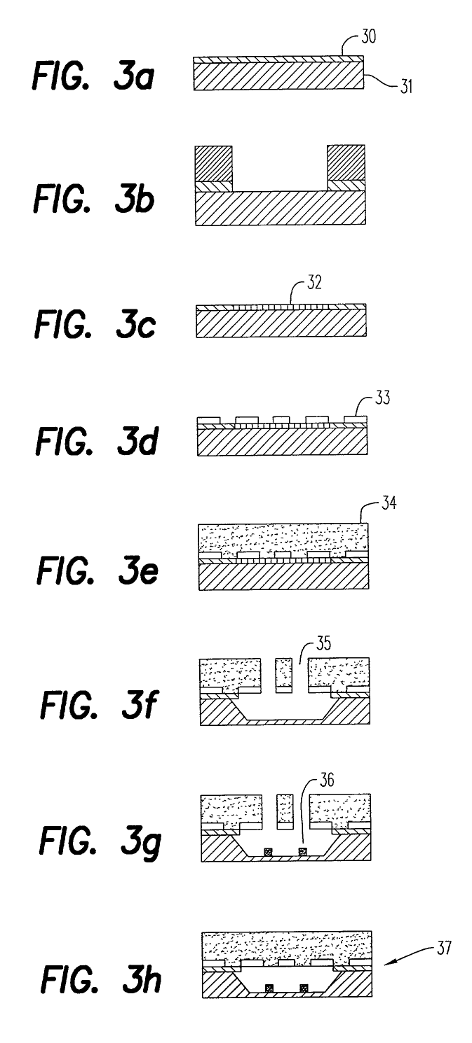

Referring to FIG. 2, there is shown a schematic representation of a length-wise cross-section of a micro-scale chemical reactor of the present invention. A reactant supply 19 enters a reactant(s) reservoir region 20. The reactant flow 17 moves through the microchannel 8 over first catalyst 24 islands and second catalyst 27 islands. Shown are reactant 15, byproduct 16, product 18, microchannel region 21, product(s) reservoir region 22, substrate 26, structural mask layer 25, and substrate 26.

The catalytic structures allow chemical reactions to take place on or because of these materials while the reactants flow through the microchannel(s). In general, as seen in the length-wise cross-section of FIG. 2, there are reservoirs at each end of the microchannel(s) 8, the reactant reservoir 20 and the product reservoir 22, to inject the reactant(s) 19 and to collect the product(s) 18, respectively. In the operation of these micro- or nanostructured chemical reactor structures, the reactant flow into the microchannel(s) because of stimuli such as capillary forces, gravitational forces, pressure difference along the microchannel(s), electrokinetic pumping, or electromagnetic forces. In general in the microchannel(s), the reactant is exposed to the catalytic islands 24 and 27 on the bottom (floor), walls or top (ceiling) of the channels or all of the above, which provide the reaction sites for a catalytic reaction. When a continuous or screen-like film, instead of islands, is used for these catalysts, it can also play an electrode role and drive electrochemical reactions or as a source of thermal energy to catalyze reactions. On the catalytic structures, a chemical reaction can take place and the byproducts are generated as the result of the reaction. A covering layer 23 may be formed if necessary. Without the covering layer, the byproducts can be removed from the chemical reactor (or additional reactant entry screen, or both, as seen in FIG. 2. The chemical or electrochemical reactants and products in the chemical reactor in this invention can be in solid phase, gaseous phase or liquid phase or a combination thereof.

We demonstrate our invention with a chemical reactor which is less than 5 millimeter in width and less than 10 millimeter in length. This micro-scale chemical reactor consists of a storing and collection means, reaction sites and plurality of micro-channel(s). The storing means provides the (1) space to store and inject the reactants or some of the reactants (reactant reservoir) and the (2) space to store and collect the products or some of the products (product reservoir). The microchannel(s) is the reactant flow path between the reactant reservoir and the product reservoir. The plurality of micro-channels are used, as necessary, to attain the product production rate necessary. The reaction occurs as at least part of the reactants travels down the channel from the reactants reservoir to the products or part of the products reservoir. During the course of this travel, the reaction or reactions are enabled or enhanced by the catalyst structures along the channel, which may be in the form of a discontinuous or continuous film or grid on the channel roof or in the form of islands, a continuous film or a grid on the channel floor. In the case of continuous films or grid structures, these materials may be electrically connected to the “outside world”. In these situations, they may be connected to an electrical voltage or current source or may serve to collect electric power, and may be involved in electrochemical processes, or may be used to enhance transport or orient polar molecules. In all these various configurations, there is the design flexibility of having additional reactants, which may enter into the channel through the ceiling grid, if present. In addition, some of the reaction products may or may not exit through the ceiling grid, if present. enhance transport or orient polar molecules. In all these various configurations, there is the design flexibility of having additional reactants, which may enter into the channel through the ceiling grid, if present. In addition, some of the reaction products may or may not exit through the ceiling grid, if present.

FIG. 1 shows the cross-sectional view of the micro-channel region of the micro-scale, chemical reactor. This micro-channel is the flow path of the reactants from the reactant reservoir to the product reservoir, as shown in FIG. 2. In this example, there is a grid catalyst on the roof (ceiling) of the channel, which can provide the reaction sites and serve as an electrode, when advantageous. Obviously, this ceiling catalyst need not be a grid with a “screen” pattern, as it has in this example. In this particular example this grid on the ceiling has also been used as a mask to create a deposited islands catalyst structure on the floor of the channel. This islands catalyst structure has been formed by depositing through the ceiling grid structure. As seen in the version of FIG. 2, there can be a covering layer over the channel. This may be permeable or differentially permeable, allowing reactants or reaction products in and out as required in a given function.

FIG. 2 shows the length-wise cross-sectional view of the overall micro-scale chemical reactor. The reactant reservoir is located at one end of the micro-channel and the product reservoir is located at the other end. The reactant is supplied to fill the reactant reservoir and starts flowing into the micro-channel due to some mechanism such as capillary force, electrophoresis, etc. While the reactant flows through the micro-channel, additional reactants can also enter through the ceiling membrane, or both. During the course of this flow reactions can take place on the catalyst islands on the floor or the catalyst on the roof of the micro-channel, or both. The byproducts are taken away toward the product reservoir, exit through the ceiling membrane, or both.

An example process sequence for fabricating such a typical micro-scale or nano-scale chemical reactor is shown in FIG. 3. At first, a structural mask layer is deposited on substrate, which may be a coated or uncoated material such as a wafer, plastic, metal foil or glass (FIG. 3a). Then, the micro-channel region and the reservoir regions are patterned by lithography and the mask layer is removed in those regions by etching (FIG. 3b). Such regions can be patterned by means other than lithography. For example, embossing or laser ablation can be used to create the pattern seen in part (b) in the mask layers and substrate. In the next step, whether the pattern is created by lithography or some other pattern-creation means, a sacrificial layer is deposited over all of the structure so that the sacrificial layer is directly deposited on the substrate and the mask-layers region(s). The sacrificial material is then removed in the mask-layers region(s) using lift-off of the mask layer resulting in the structure of FIG. 3c. The structural mask layer should have low etch or dissolution rate in the lift-off step so that this structural mask layer remains on the substrate everywhere except in the micro-channel and reservoir regions.

In this general process flow, the ceiling catalyst layer 33 (first catalyst layer) may be formed by methods such as laser ablation, the use of a shadow mask, or processing comprising lithography, deposition, etching, and lift-off. Whichever of these approaches is used, the result is that seen in FIG. 3d. The resulting first layer may or may not be in, at least partially, the form of a (screen morphology) grid. A covering layer 34 can then be deposited, if advantageous, on top of such a catalyst layer (FIG. 3e). This covering layer 34, when present, may be permeable or semipermeable to reactants or reaction products, or both. Next etching holes 35 may be patterned in such a layer by photolithography and dry etching, or by ablation. This allows an etching solution access to the sacrificial layer and the sacrificial layer can be etched or dissolved away. Alternatively access to the sacrificial layer for its removal can be up through the substrate from the back. In either case, part of the substrate, when designed into the process, can also be etched by the solution for further creating the micro-channel and reservoir regions (FIG. 3f). Then, 2^{nd} catalyst material is deposited through the etching hole 35 to generate islands catalysts 36 on the floor of the micro-channel (FIG. 3g). The etching hole is filled up by conformal deposition of the covering layer. Since the covering layer can be deposited on the sidewall of the etching hole, additional deposition of covering layer results in the pinch-off in the etching hole (FIG. 3h) to provide a chemical reactor 37. This covering layer again can be permeable or semi-permeable to reactants, reaction products, or both.

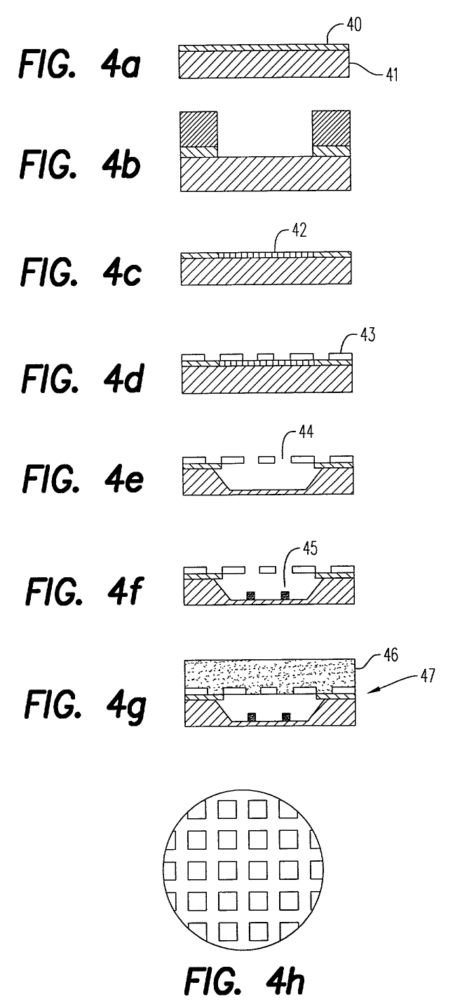

Referring now to the process sequence for manufacturing a micro-scale chemical reactor of the present invention shown in FIG. 4, FIG. 4a shows structural mask 40 deposition on a substrate 41. FIG. 4b shows a lithography step etching the mask layer. FIG. 4c shows the step of depositing a sacrificial layer and lift-off. FIG. 4d shows a lithography step, anode 43 layer deposition and lift off. FIG. 4e shows a lithography step, through hole 44 etching, and removing of release layer. FIG. 4f shows catalyst 45 island layer deposition. FIG. 4h shows a top view of the grid or screen-like structure of the anode layer 43.

If the catalyst on the ceiling is in the form of a grid, it may be used as a mask for depositing an island catalytic structure on the channel floor. This can be accomplished as shown in FIG. 3g or in the process flow of FIG. 4. Alternatively, continuous films or grids can be fabricated on the floor by accomplishing their creation prior to the sacrificial layer deposition. In FIG. 4, the procedure followed has resulted in making the first (ceiling) catalyst pattern in the form of a grid as discussed above (FIG. 4d). Then, there is a second catalyst deposition using this grid as a mask to create catalyst islands generated by through-hole deposition of the catalyst materials. This procedure is beneficiary because it is simpler than that of FIG. 3g; i.e., in FIG. 4g there is no need to remove catalyst not down on the channel floor since this non-needed catalyst simply resides on the backside of the top the grid pattern.

### Application of the Invention

(1) Micro-scale and Nano-scale Chemical Reactors

A chemical reaction which requires a catalyst or catalysts to enhance or enable the reaction can readily take place in the micro-scale or nano-scale, chemical reactor of this invention.

For example, cyclohexane is known to react on a catalytic surface to generate hydrogen gas and benzene. If a cyclohexane molecule, C6H12 flows through the microchannels with an appropriately chosen catalyst grid on the ceiling, catalyst islands on the floor, or both then a catalytic reaction takes place on the catalyst;

C6H12⇄3H2+C6H6.

In this reaction, a benzene molecule is generated from a cyclohexane for fuel generation. During the reaction, three hydrogen molecules are also generated from one cyclohexane molecule as the byproducts. This byproduct hydrogen can be passed through the grid catalyst pattern of the ceiling, as seen in the FIG. 2, for example, while the product C6H6 flows to the collection product reservoir. This Micro-scale Chemical Reactor concept is seen, in the case of this particular example, to yield hydrogen gas as byproduct. If desired, such gas is easily collected in collector micro-fluidic structures, which could be above the covering layer (not shown) in FIG. 2.

(2) Micro-scale and Nano-scale Electro-chemical Reactors

As noted earlier, the deposited films built into the ceiling, floor, or both of the micro-scale chemical reactors can serve a catalytic function, a voltage or current source or power collector function, a transport/orientation function, or some combination of all three. When these structures serve for voltage/current/power source/collection functions, they may be used to support electrochemical reactions.

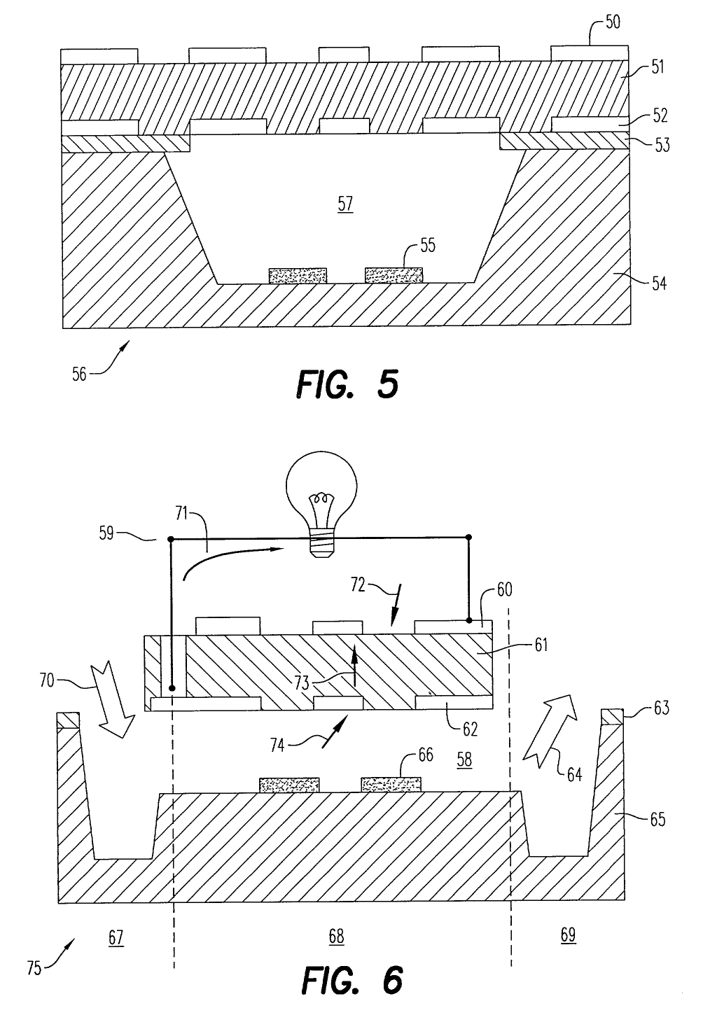

Referring now to FIG. 5, there is shown a cross-section of a micro-scale, electro-chemical reactor (fuel cell) of the present invention. Shown is a first electrode 50, a membrane 51, a second electrode 52, a structural mask layer 53, substrate 54, and catalyst 55 islands disposed on the floor of a microchannel 57.

We demonstrate this use of our structures for Electro-chemical reactors by specifically discussing the case of the hydrogen-based fuel cell. FIG. 5 shows the cross-sectional view of such a fuel cell, which is seen to have the same channel structure of the micro-scale, chemical reactor. In this case there is a membrane 51 covering the catalyst on the ceiling, which serves as proton conducting material. This membrane is used as the covering layer for fuel cell operation so that the protons generated on the anode catalyst diffuse through the membrane to the top reaction sites. These top reaction sites are on an additional catalyst layer formed on the membrane to provide the reaction sites for the cathode reaction of the fuel cell. As seen in the general depiction of FIG. 5, there may also be a catalyst layer on the micro-channel floor, if beneficial. In the case of a general electrochemical reactor, this layer may also be continuous and serve as another electrode.

This basic structure is also possible to use with the reactant supply arriving at the outer (upper) surface of FIG. 5. In this way, the upper electrode layer can be used as the catalyst layer at which, for example, proton production occurs in fuel cell applications. It is advantageous to use the upper electrode as reaction site because the upper electrode can be designed to have larger surface area than that of 1^{st} catalyst electrode. The area of the 1^{st} catalyst layer is confined in the configuration of FIG. 5 to within only the ceiling area of microchannel(s) and the width of microchannel(s) can be limited to maintain the minimal mechanical strength to support the microchannel(s) to prevent from collapse. Therefore, the upper electrode can provide of the larger surface catalyst site at which the catalytic reaction occurs.

(3) Combination Micro-scale and Nano-scale Chemical/Electro-chemical Reactors

Referring now to FIG. 6, there is shown a length-wise cross-section of the combination micro-scale chemical/electrochemical reactor 75 of the present invention (i.e., a fuel cell). Shown is reactant supply 70, reactants reservoir region 67, microchannel 58, microchannel region 68, product(s) reservoir region 69, hydrogen 74, byproduct 64, proton 73, substrate 64, mask layer 63, anode 62, proton conductor 61, cathode 60, oxygen 72, and electron 71.

With the approach of this invention, combination micro-scale or nano-scale chemical/electro-chemical reactors may be effectively created. This is demonstrated with the specific example of FIG. 6. FIG. 6 shows the operation of a fuel cell with a built-in embedded hydrogen-generating micro-scale, chemical reactor beneath the fuel cell. A reactant flows through the micro-channel 58 generating hydrogen molecules 74 as the byproduct within the micro-channels. For example, a cyclohexane molecule generates three hydrogen molecules and a benzene molecule. The hydrogen molecule can be oxidized on catalyst surface 66 to generate a proton 73 and an electron 71. Then, the proton 73 diffuses into the membrane proton conductor 61 toward the cathode catalyst 60 and the electron 71 is collected by the electrical connection to the external circuit 59. Therefore, the anode 62 plays roles of catalyst as well as electron collector in this particular application. On the cathode 60, the proton 73 which penetrates the proton conductor 61 meets with the electron 71 and the oxygen 72 from some source or the environment. The resulting cathodic reaction takes place to make a water molecule. Therefore, this micro-scale, reactor of FIG. 6, used here as an example of a chemical/electro-chemical reactor combination application, is capable of providing hydrogen, which is used to generate electricity and of providing benzene, which can be used as a fuel, from cyclohexane. A process flow that can be used to create the device of FIG. 6 is seen in FIG. 8.

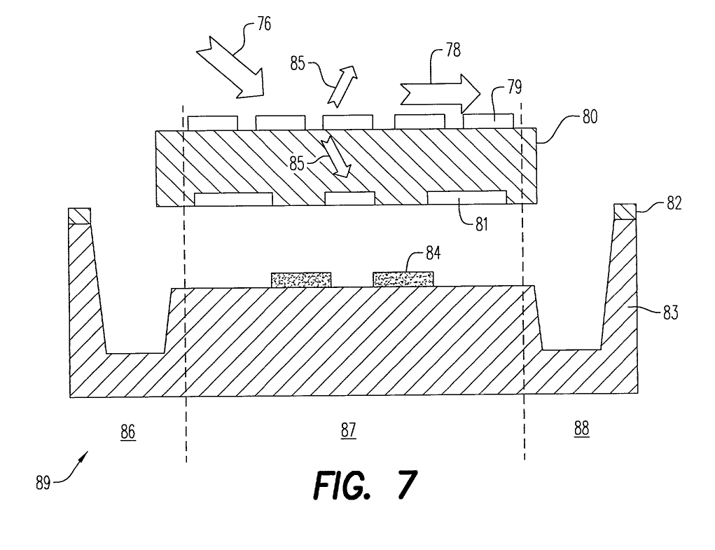

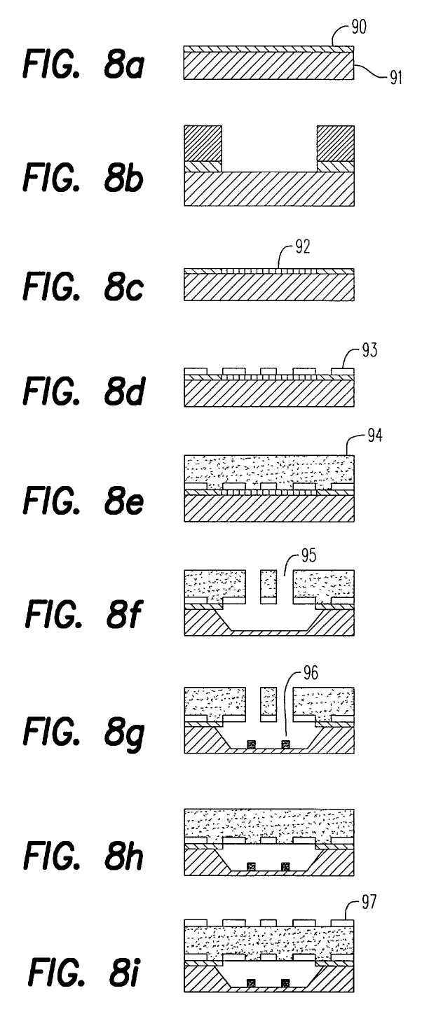

Referring now to FIG. 7, there is shown a length-wise cross-section of a micro-scale chemical reactor 89 of the present invention with the reactants on the outer surface. Shown is reactant(s) reservoir region 86, microchannel region 87, products reservoir region 88, first catalyst island 81, second catalyst island 84, substrate 83, structural mask layer 82, covering layer 80, byproduct 85, reactant supply 76, product 78, upper catalyst layer 79 and covering layer 80.

Referring now to FIG. 8, there is shown a schematic representation of a process sequence for the preparation of a fuel cell of the present invention with an in situ hydrogen-generating chemical reactor. FIG. 8a shows a substrate 91, and a structural mask layer 90. FIG. 8b shows a lithography step with etching of the mask layer. FIG. 8c shows deposition of the sacrificial layer 92 with lift-off. FIG. 8d is a lithography step, with anode layer 93 deposition, lift-off. FIG. 8e shows membrane 94 deposition. FIG. 8f shows lithography, through hole 95 etching, and release layer removing. FIG. 8g shows catalyst layer (islands) 96 deposition. FIG. 8h shows through hole sealing. FIG. 8i shows lithography cathode layer 97 deposition and lift-off.

In this structure (c.f., FIG. 7), it is also possible to supply reactants to the outer surface and use the upper electrode layer as the catalyst layer. It is also advantageous to use the upper electrode as reaction site because the upper electrode can be designed to have larger surface area than that of 1^{st} catalyst electrode. The area of the 1^{st} catalyst layer is confined within only the ceiling area of microchannel(s) and the width of microchannel(s) can be limited to maintain the minimal mechanical strength to support the microchannel(s) to prevent from collapse. Therefore, using the upper electrode in this manner can provide a larger surface catalyst at which the catalytic reaction occurs. For example, if cyclohexane is supplied to the top surface, the catalytic reaction occurs on the surface of upper electrode and the byproducts will remain on the surface, or permeate through the covering layer if the layer is permeable to the byproducts or both. If the covering layer is conductive to proton or hydrogen or both, the byproduct hydrogen from cyclohexane reaction diffuses into the covering layer after the catalytic reaction on the electrode.

(4) Thin-Film Membrane Catalyst or Catalyst/Electrode Assembly

In both chemical and electrochemical reactors, the presence of a membrane play can an important part in the overall reaction in that the membrane can be selected to be permeable to only some reactants and/or byproducts and not permeable to others. This importance can be especially true in electrochemical reactors. For example, in a hydrogen fuel cell, the membrane is crucial since it is permeable to protons but not to electrons. In this way the presence of the membrane can lead to its sustaining a chemical potential from one side to the other. In the example of the fuel cell case, electrode/catalyst structures on the each side of the membrane catalyze the reactions leading to the development of the electrochemical potential across the membrane.

In this invention, we disclose a very general approach to fabricating such membranes with catalyst (chemical reactor case) or electrode/catalyst (electrochemical reactor case) structures on each side. In this approach the membrane-catalyst or membrane-electrode/catalyst structure may or may not have integrated reaction/product fluidic structures. We term this approach membrane catalyst assembly (MCA) or membrane electrode assembly (MEA), as appropriate.

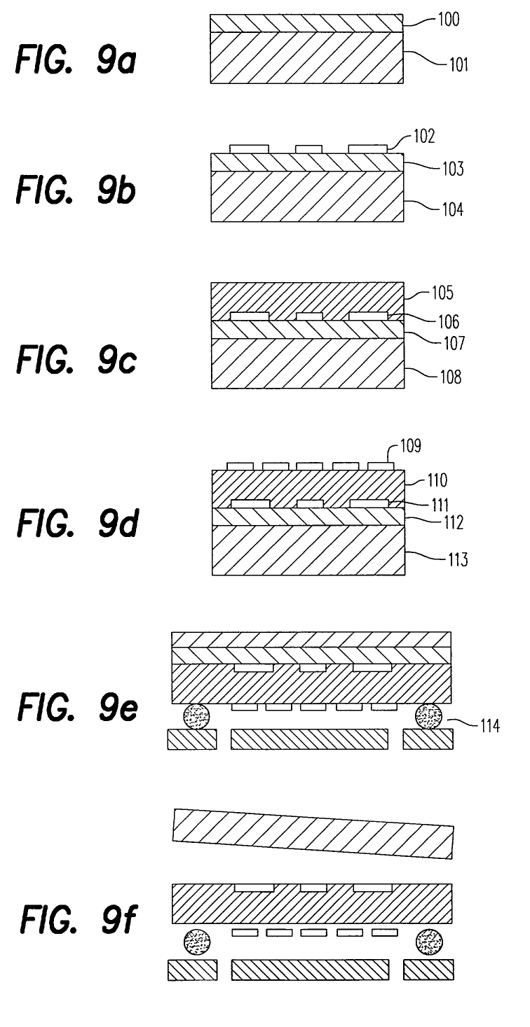

FIG. 9 is a schematic representation of the process steps preparing a chemical reactor of the invention, which combines a membrane electrode assembly (MEA) and pre-designed flow field. FIG. 9a shows deposition of a sacrificial layer 100 on a substrate 101. FIG. 9b illustrates lithography, deposition and lift-off for a first catalyst layer 102; shown is release layer 103 and substrate 104. FIG. 9c shows deposition of a covering layer 105; shown is substrate 108, release layer 107, and first catalyst 106 (island). FIG. 9d illustrates lithography, deposition and lift-off for a first catalyst layer 111; shown is substrate 113, release layer 112, covering layer 110, and upper catalyst 109. FIG. 9e shows a step where the device is flipped over and positioned on a separator 114. FIG. 9f shows a step removing the release layer.

In the following discussion we focus on the MEA case for fuel cell applications, since the MCA case is simply a situation where the catalyst layers are not also functioning as electrodes. Our approach is outlined in FIG. 9. As seen it entails first fabricating the 1^{st} catalyst layer in a grid, dot or other high surface to volume configuration onto a release layer. This release layer is on a disposable or reusable “mother” substrate. When this catalyst layer is functioning as an electrode, as it is in the MEA case, this configuration must accommodate electrical connection to the “outside world” as discussed above. Many types of release layer materials and release layer approaches are available for this application such as column-void network porous silicon, plastics, photoresist, volatilizable polycarbonate, etc. The release layer is selected to facilitate ease of separation from the mother substrate in a later step after formation of the electrode/membrane/electrode sandwich. The release layer is etched or dissolved selectively so that the MEA (or MCA, as appropriate) can be separated after the formation on the layer. As seen in FIG. 9, the electrode/membrane/electrode sandwich is formed by the sequencing of the 1^{st} catalyst, covering layer, and upper catalyst layers. In the MEA case, this upper catalyst layer also has the same electrode role as the 1^{st} catalyst layer. The covering layer must be a differentially permeable membrane in many applications. For example, in the hydrogen fuel cell MEA case, this membrane must support proton conduction but block electron conduction.

After reaching the point indicated by FIG. 9d, the separation step can be undertaken as seen in FIG. 9e. As seen in this figure, the structure has been flipped over using the mother substrate as a carrier and positioned on separators. These separators could be glass or plastic balls or rods, for example, and they are positioned (1) to provide mechanical support, (2) to define the reactant (or product) flow path but (3) to do so while minimizing fluid flow interference. These separators could also be structures formed into pre-designed flow panel and created by a variety of processes including etching, ablation, molding, or embossing. This panel would then be attached on the MEA (or MCA), as seen in FIG. 9e, so that the reactant has access to the catalyst on MEA surface.

Once the system is in place as seen in FIG. 9e, the release layer is removed by a removal process such as etching, dissolution, or sublimation thereby freeing the mother substrate, which may be reusable. In this release step, access holes may be necessary and these can be formed either through the MEA or through the substrate from backside. The removal process is seen in FIG. 9f. At this stage another flow panel can be attached to the MEA. Alternatively, using the hydrogen fuel cell as an example, this just released side can be left exposed to the air to allow oxygen access. In this case the hydrogen baring fuel would arrive through the channels created by the spacer and/or flow panel attachment.

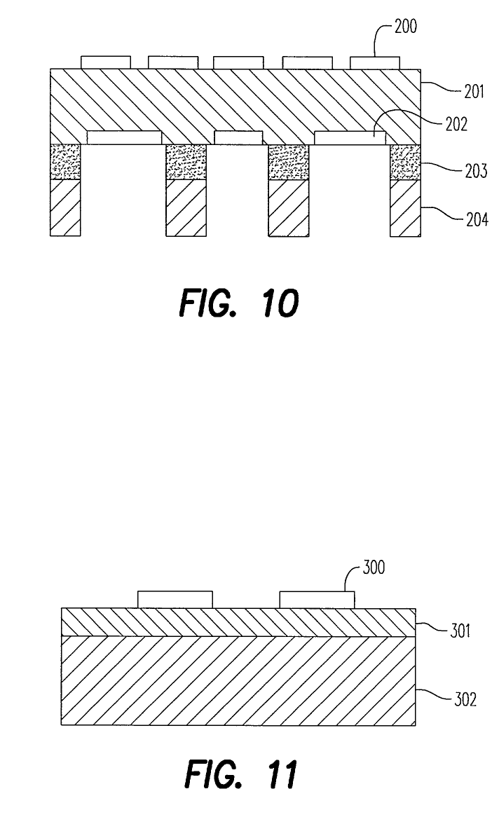

FIG. 10 is a schematic representation of a chemical reactor of the present invention, which has flow field by etching part of the substrate 204 and sacrificial layer 203. Shown are a first catalyst 202, a covering layer 201, and an upper catalyst 200.

In an alternative, the substrate 202 does not function as a removable carrier but is retained, as seen in FIG. 10. In this approach, the flow field can be made by etching, ablating, embossing, etc away part of the substrate 202 from backside and there is no need for any release layer of any type FIG. 10 shows the grooves formed beneath the electrode in substrate, in this approach. This is flow field creation is after the MEA is formed. The flow access to the other catalyst surface in this case can be by either of the methods discussed above. The structures of sections (1) through (3) above and, in particular, the MCA and MEA methodologies outlined above allow the use of unique deposited materials for the membrane. In particular they allow the use of porous high surface to volume ratio materials such as deposited column-void network silicon, which we have already established is an effective proton conductor material.

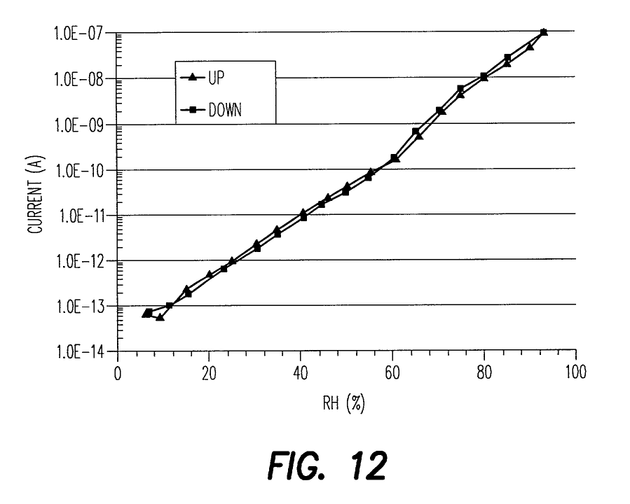

An example of an MEA lateral sandwich structure using our deposited column-void network silicon as a proton conductor is presented in FIG. 11. FIG. 11 is a schematic representation of a test structure for proton conduction through the high-surface-to-volume-ration material 302 deposited by plasma enhanced chemical vapor deposition (PECVD). Here, Al Island electrodes 300 were formed on a deposited high-surface-to-volume ratio material 301 on a substrate 302 as shown in FIG. 11. Resistance between two island electrodes 300 was measured with the relative humidity in the environment of the structure. FIG. 12 shows the current between the electrodes increases with the environmental humidity. The higher current is resulted from the more protonic conduction in humid environment. Since the high-surface-to-volume-ratio material has a huge number of adsorption conduits for a water vapor from the environment, the water vapor adsorbed on the surface of the material results in the decrease of resistance between two electrodes. When this Si surface interacts with humidity, the formation of hydroxyl ions (protonated water) occurs. Proton transport then takes place by hydroxyl ion motion or when H3O+ releases a proton to a neighboring H2O transforming it into H3O+, and so forth. The latter effect is known as the Grotthuss chain reaction. When there are electrodes made of catalytic metals, such as Pd and Pt, instead of Al, a proton generated from catalytic reaction from those electrodes will transfer through the deposited high-surface-to-volume ratio material giving proton conduction The lowest current level in this figure is due to the electron conduction demonstrating the strong differentially permeable nature of this class of new membrane materials.

In a further embodiment of the device the membrane structure may be formed in situ, during device fabrication by catalyzing a chemical reaction, chemically, thermally, electrically, electrochemically or by photo-promotion or initiation. This allows the membrane to be formed precisely inside channels or reaction chambers or reservoirs.

Although the present invention describes in detail certain embodiments, it is understood that variations and modifications exist known to those skilled in the art that are within the invention. Accordingly, the present invention is intended to encompass all such alternatives, modifications and variations that are within the scope of the invention as set forth in the following claims.

What is claimed is:

1. A reactor device comprising at least one of each of the following:
a first cavity for storing one or more reactants;
a second cavity for collecting a product formed from said one or more reactants;
a channel disposed between said first cavity and said second cavity for permitting said one or more reactants to flow from said first cavity to said second cavity; and
a means disposed between said first cavity and said second cavity for converting said one or more reactants to said product, wherein said device is in the range from about nano to about micro-scale.

2. The device of claim 1, wherein said means for converting said one or more reactants to said product is selected from the group consisting of catalyst, electrode, chemical composition, and combinations thereof.

3. The device of claim 1, wherein said means for converting said one or more reactants to said product is an electrode.

4. The device of claim 1, wherein said means for converting said one or more reactants to said product is a chemical composition.

5. The device of claim 1, wherein said means for converting said one or more reactants to said product is a catalyst.

6. The device of claim 5, wherein said catalyst is in the form of at least one island.

6. The device of claim 5 further comprising an anode and a cathode.

7. The device of claim 1, wherein said means for converting said one or more reactants is a catalyst disposed in the form of at least one island on a side wall, ceiling, floor surface, or combinations thereof, forming said channel.

8. The device of claim 1, further comprising a covering layer.

9. The device of claim 8, wherein said means for converting said one of more reactants is a first catalyst disposed in the form of at least one island on the upper surface of said covering layer and in the form of at least one island on the lower surface of said covering layer.

10. The device of claim 9, further comprising a second catalyst disposed in the form of at least one island on the lower or floor surface of said channel.

11. The device of claim 1, further comprising a covering layer that is a proton conductor.

12. The device of claim 11, wherein disposed on one surface of said covering layer is a cathode, disposed on a second surface of said covering layer is an anode, and wherein said means for converting said one or more reactants is a catalyst disposed in the form of at least one island on the lower surface forming said channel.

13. The device of claim 1, wherein said means for converting said one or more reactants to said product is a continuous film, a discontinuous film, or a grid or screen-like film.

14. The device of claim 1, wherein said device is about 5 mm or less in width and about 10 mm or less in length.

15. A method for producing a micro or nano-scale reactor device on a substrate comprising:
depositing onto a substrate a structural mask layer;
patterning at least one channel region, at least one reactant reservoir region, and at lest one product reservoir region of said mask layer;
depositing a sacrifical layer material on said substrate and patterned regions of said mask layer;
removing said sacrificial layer material of said mask layer regions by lifting-off said mask layer to provide mask layer on said substrate except in said channel, reactant reservoir, and product reservoir regions;
patterning a first catalyst layer and thereafter depositing a thin-film catalyst layer on said substate and lifting-off said thin film catalyst layer;
depositing a first covering layer;
etching at least one hole through said covering layer, sacrificial layer, and a portion of said substrate;
depositing a second catalyst layer on said substrate; and
sealing said at least one through hole by depositing a second covering layer.

16. The method of claim 15, wherein said substrate is selected form the group consisting of semiconductors, glasses, plastics, polymers, metals, ceramics, insulators, organic materials, inorganic materials, and any combinations thereof.

17. The method of claim 15, wherein said structural mask layer is selected from the group consisting of coated wafers, coated plastic material, coated metal material, coated foil materials, coated glass materials, unquoted wafers, unquoted plastic materials, unquoted metal materials, unquoted foil materials, unquoted glass materials, and any combinations thereof.

18. The method of claim 15, wherein said patterning comprises lithography, embossing or laser ablation.

19. The method of claim 15, wherein said first catalyst layer and said second catalyst layer are selected form the group consisting of: noble metals, active metals, transition metals, non-metals, alkali metals, alkaline earth metals, halogens combinations thereof, and specifically platinum, palladium, platinum alloys and palladium alloys

20. The method of claim 15, wherein said first catalyst layer, said second catalyst layer, or both catalyst layers are patterned as a grid or screen.

21. The method of claim 15, wherein at least one catalyst layer is an island.

22. The method of claim 15, wherein said covering layer is selected from the group consisting of: semiconductors, glasses, plastics, polymers, metals, ceramics, insulators, organic materials, inorganic materials, and any combinations thereof.

23. The method of claim 15, wherein said covering layer is a proton conducting membrane layer.

24. The method of claim 23, further comprising depositing an electrode on said substrate.

25. The method of claim 15, wherein said covering layer is a high surface to volume ratio material.

26. The method of claim 25, wherein said high surface to volume ratio material is deposited column-void silicon.

27. The method of claim 15, wherein said first catalyst layer and said second catalyst layer are electrode layers.

28. The method of claim 15, wherein depositing of said structural mask layer, said sacrificial layer, said first catalyst layer, said covering layer, and said second catalyst layer is by physical vapor deposition, chemical vapor deposition, liquid deposition, molecular beam epitaxy, plasma assisted chemical vapor deposition, sol-gels, nebulization, spraying, electroplating, tape casting, spin coating, assembly form liquid chemical precursors, printing, self-assembly, and any combinations thereof.

29. The method of claim 15, wherein at least on deposited layer is a continuous film, a discontinuous film or any combinations thereof.

30. A micro or nano-scale reactor device prepared by the process comprising:
depositing onto a substrate a structural mask layer;
patterning at least one channel region, at least one reactant reservoir region, and at lest one product reservoir region of said mask layer;
depositing a sacrificial layer material on said substrate and patterned regions of said mask layer;
removing said sacrificial layer material of said mask layer regions by lifting-off said mask layer to provide mask layer on said substrate except in said channel, reactant reservoir, and product reservoir regions;
patterning a first catalyst layer and thereafter depositing a thin-film catalyst layer on said substrate and lifting-off said thin film catalyst layer;
depositing a first covering layer;
etching at least one hole through said covering layer, sacrificial layer, and a portion of said substrate;
depositing a second catalyst layer on said substrate; and
sealing said at least one through hole by depositing a second covering layer.

31. The device of claim 30, wherein said substrate is selected form the group consisting of semiconductors, glasses, plastics, polymers, metals, ceramics, insulators, organic materials, inorganic materials, and any combinations thereof.

32. The device of claim 30, wherein said structural mask layer is selected from the group consisting of coated wafers, coated plastic material, coated metal material, coated foil materials, coated glass materials, uncoated wafers, uncoated plastic materials, uncoated metal materials, uncoated foil materials, uncoated glass materials, and any combinations thereof.

33. The device of claim 30, wherein said patterning comprises lithography, embossing or laser ablation.

34. The device of claim 30, wherein said first catalyst layer and said second catalyst layer are selected from the group consisting of: noble metals, active metals, transition metals, non-metals, alkali metals, alkaline earth metals, halogens combinations thereof, and specifically platinum, palladium, platinum alloys and palladium alloys

35. The device of claim 30, wherein said first catalyst layer, said second catalyst layer, or both catalyst layers are patterned as a grid of screen.

36. The device of claim 30, wherein at least one catalyst layer is an island.

37. The device of claim 30, wherein said covering layer is selected from the group consisting of: semiconductors, glasses, plastics, polymers, metals, ceramics, insulators, organic materials, inorganic materials, and any combinations thereof.

38. The device of claim 30, wherein said covering layer is a proton conducting membrane layer.

39. The device of claim 38, further prepared by depositing an electrode on said substrate.

40. The device of claim 30, wherein said covering layer is a high surface to volume ratio material.

41. The device of claim 40, wherein said high surface to volume ratio material is deposited column-void silicon.

42. The device of claim 30, wherein said first catalyst layer and said second catalyst layer are electrode layers.
